(19) United States
(12) Patent Application Publication
(10) Pub. No.: US 2011/0061759 A1
(43) Pub. Date: Mar. 17, 2011

(54) Adjustable tube assembly

(75) Inventor: Yann-Shoou Chen, Hsinchu City (TW)

(73) Assignee: Ho-Chin Chen, Taichung County (TW)

(21) Appl. No.: 12/585,325

(22) Filed: Sep. 11, 2009

(51) Int. Cl. F16L 39/04; F16L 7/00

(52) U.S. Cl. 138/108; 138/114; 138/178

(57) ABSTRACT

A tube assembly includes an outer tube with ribs in the inner periphery thereof and a sleeve is mounted to the outer tube and an operation unit is located in the outer tube. The operation unit includes a first part and a second part which is threadedly connected to the first part. The second part includes multiple expandable plates extending axially therefrom. An inner tube unit has a connection member connected to an end thereof and the connection member is fixed to the first part and includes a tapered flange which is moved to control the expandable plates to contact or removed from the inner periphery of the outer tube when adjusting the inner tube relative to the outer tube.

### FIELD OF THE INVENTION

The present invention relates to a tube assembly, and more particularly, to an adjustable tube assembly wherein the inner tube is adjustable axially relative to the outer tube by operation of an operation unit in the outer tube.

### BACKGROUND OF THE INVENTION

A conventional tube assembly is shown in FIGS. 8 and 9, and generally includes an outer tube 5, an inner tube 6, a locking collar 7 and a control sleeve 8, wherein a seal member 61 is located in the outer tube 5 so as to seal between the inner and outer tubes 6, 5. The outer tube 5 includes a connection member 51 located at an end thereof and the connection member 51 includes outer threads 52. The locking collar 7 is mounted to a plan section at the end with the outer threads 52. The control sleeve 8 is mounted to the inner tube 6 and includes inner threads 81 so as to be threadedly connected to the outer threads 52. The locking collar 7 includes a tapered end 72 which includes axial slots 71. The control sleeve 8 includes a tapered inner periphery 82 which movably presses the tapered end 72 so as to lock the inner tube 6.

When adjusting the inner tube 6 relative to the outer tube 5, the control sleeve 8 is first rotated to remove the tapered inner periphery 82 from the tapered end 72 of the locking collar 7, and the inner tube 6 is moved relative to the outer tube 5. When the desired position of the inner tube 6 is reached, the user rotates the control sleeve 8 in reverse direction to press the tapered end 72 again to tighten the inner tube 6 again. However, in order to reduce risk of wearing of the inner tube 6, the user has to make sure that the tapered inner periphery 82 is completely separated from the tapered end 72 he or she adjust the inner tube 6. This is not convenient for the user and wastes time because of low efficiency.

The present invention intends to provide a tube assembly which is easily to adjust the inner tube relative to the outer tube.

### SUMMARY OF THE INVENTION

The present invention relates to a tube assembly and comprises an outer tube with a sleeve having an end fixedly connected to the outer tube. An operation unit is located in the outer tube and includes a first part and a second part. The first part is threadedly connected to the second part. The second part includes multiple expandable plates extending axially from a second end thereof and slits are defined between the expandable plates which contact an inner periphery of the outer tube when being expanded. An inner tube unit includes an inner tube and a connection member which is connected to a first end of the inner tube. The connection member is inserted into the operation unit and fixed to the first part of the operation unit. A tapered flange extends radially from the connection member so as to expand the expandable plates outwardly when rotating the inner tube.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the tube assembly of the present invention;

FIG. 2 is another exploded view to show the tube assembly of the present invention, wherein the connection member on the inner tube is connected to the operation unit;

FIG. 3 is a perspective view to show the tube assembly of the present invention;

FIG. 4 is a cross sectional view to show the connection member and the operation unit;

FIG. 5 is a cross sectional view to show that the inner tube is rotated;

FIG. 6 is a cross sectional view to show that the tapered flange is moved away from the expandable plates and the inner tube is able to move relative to the outer tube;

FIG. 7 is a cross sectional view to show that the inner tube is moved a desired position and the inner tube is rotated to expand the expandable plates to contact the outer tube;

FIG. 8 is an exploded view to show the conventional tube assembly, and

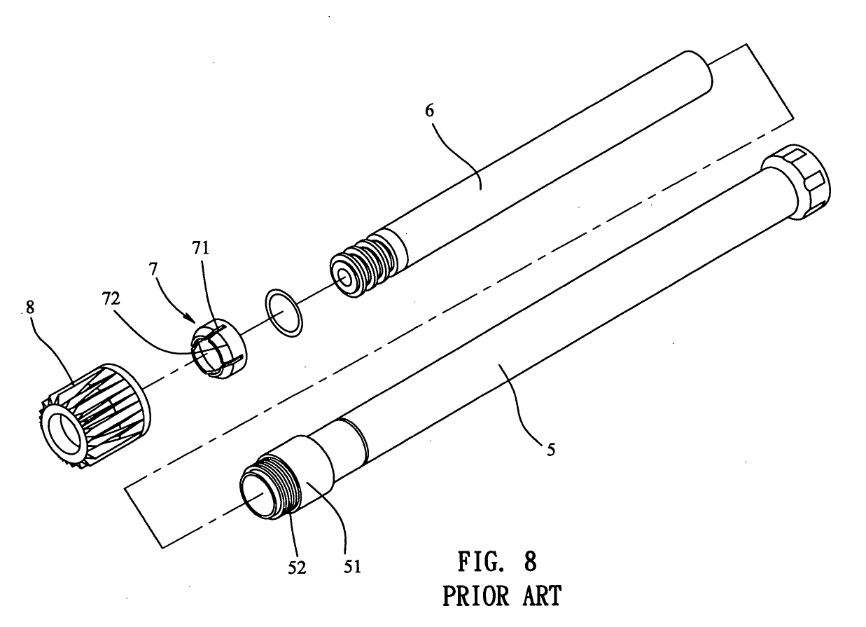

FIG. 9 is a cross sectional view of the conventional tube assembly.

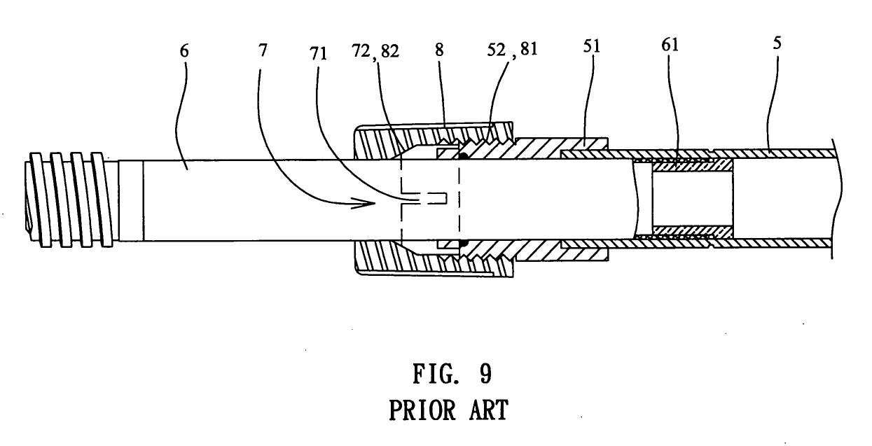

### DETAILED DESCRIPTION OF THE PREFERRED EMBODIMENT

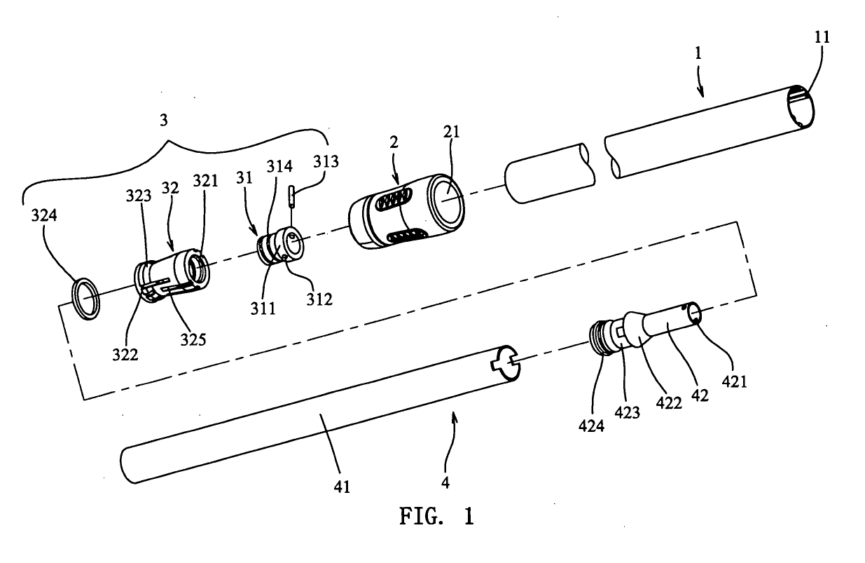

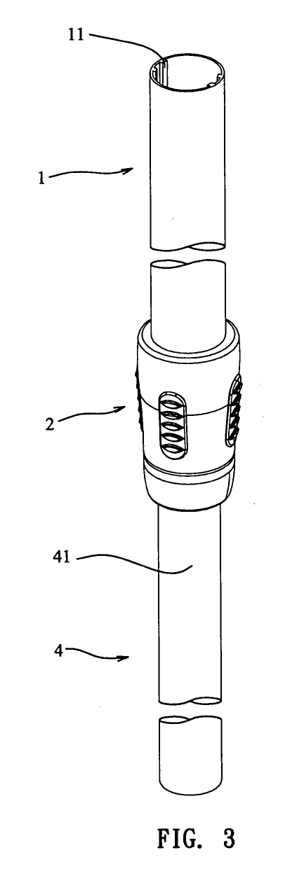

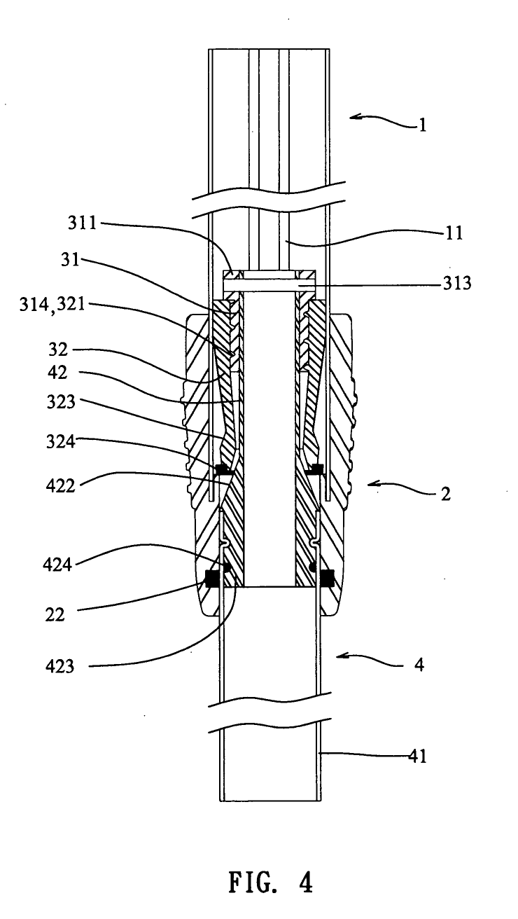

Referring to FIGS. 1 to 4, the tube assembly of the present invention comprises an outer tube 1 which includes multiple ribs 11 extending axially on the inner periphery of the outer tube 1. A sleeve 2 has includes a tapered inner periphery and includes a stepped opening 21 in a first end thereof. The outer tube 1 is inserted into and fixed to the sleeve 2 via the stepped opening 21. Another opening is defined in a second end of the sleeve 2 and an inner tube 41 is inserted into the sleeve 2 via the another opening. A seal ring 22 is engaged within the sleeve 2 and mounted to the inner tube 41 so as to prevent leakage between the inner and outer tubes 41, 1.

An operation unit 3 is located in the outer tube 1 and includes a first part 31 and a second part 32, wherein the first part 31 has outer threads 314 on a first end thereof and the second part 32 has inner threads 321 in a first end thereof. The inner threads 321 of the second part 32 are connected to the outer threads 314 of the first part 31. The first part 31 includes an enlarged head 311 on a second end thereof and two first holes 312 are defined through a wall of the enlarged head 311. A pin 313 extends through the first holes 312. The second part 32 include multiple expandable plates 323 extending axially from a second end thereof and slits 322 are defined between the expandable plates 323 which contact an inner periphery of the outer tube 1 when being expanded. A seal ring 324 is mounted onto the expandable plates 323 of the second part 32. The second part 32 of the operation unit 3 includes multiple grooves 325 defined in an outer surface thereof and the ribs 11 of the outer tube 1 are engaged with the grooves 325 such that the second part 32 does not rotate relative to the outer tube 1 and can move along the ribs 11.

An inner tube unit 4 including the inner tube 41 mentioned above and a connection member 42 which is connected to a first end of the inner tube 41. The connection member 42 is inserted into the operation unit 3 and the connection member 42 includes two second holes 421 defined in a first end thereof. The pin 313 extends through the second holes 421 which are in alignment with the first holes 312 of the first part 31 so as to connect the connection member 42 with the first part 31. A tapered flange 422 extends radially from the connection member 42 so as to expand the expandable plates 323 outwardly when the tapered flange 422 moves.

A connection portion 423 is located on a second end of the connection member 42 and beside the tapered flange 422. The outer diameter of the connection portion 423 is smaller than that of the tapered flange 422. The connection portion 423 is inserted into the inner tube 41. A seal ring 424 is mounted to the connection portion 423.

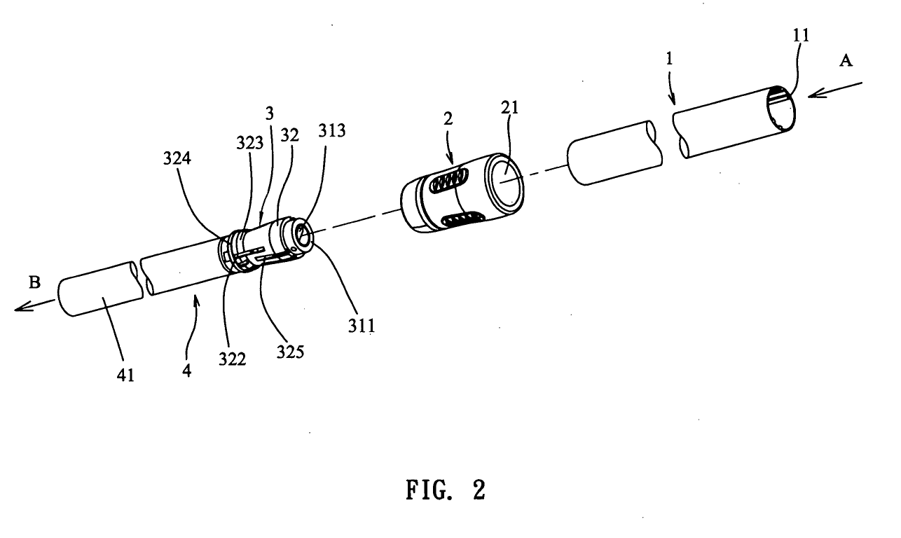

When assembling, the connection member 42 is inserted into the inner tube 41 and the pin 313 extends through the aligned first and second through holes 312, 421 to connect the connection member 42 to the first part 31 of the operation unit 3. The expandable plates 323 of the second part 32 are located outside of the tapered flange 422. The outer tube 1 is inserted into the sleeve 2 and fixed to the sleeve 2 and the outlet end “B” which is the second end of the inner tube 41 is inserted into the outer tube 1 from the end “A” as shown in FIG. 2. The ribs 11 of the outer tube 1 are engaged with the grooves 325 of the second part 32, so that the inner tube 41 can be moved axially along the ribs 11 relative to the outer tube 1.

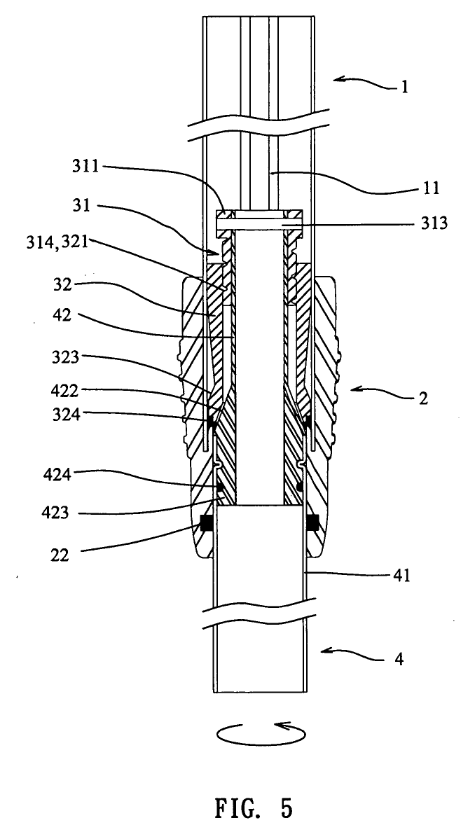

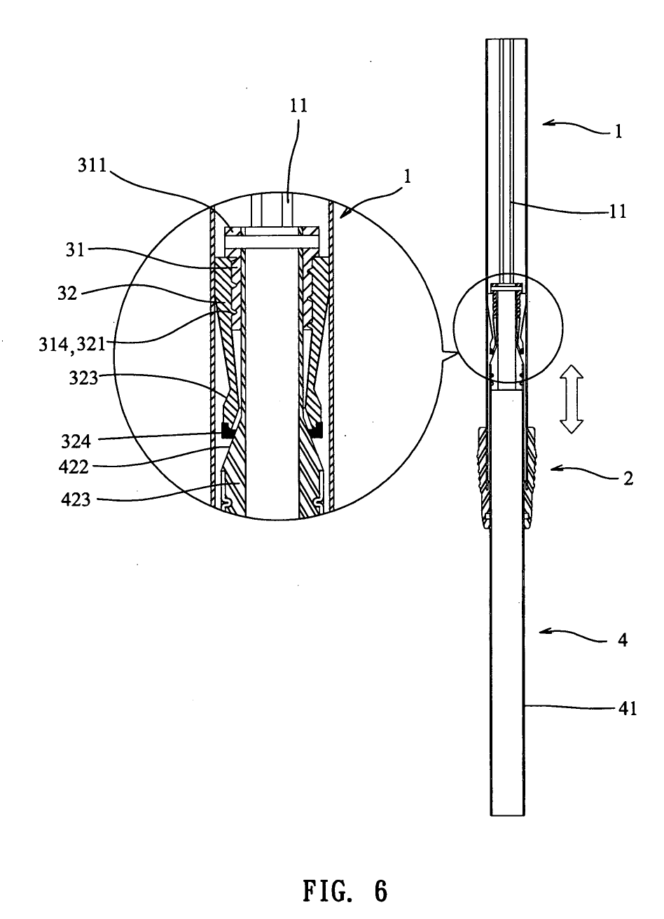

As shown in FIG. 5, before adjusting, the expandable plates 323 are in contact with the inner periphery of the outer tube 1 so as to position the inner tube 41 relative to the outer tube 1. When adjusting, the user rotates the inner tube 41 relative to the outer tube 1 and the first part 31 is rotated with the inner tube 41. Because the first part 31 is threadedly connected to the second part 32 which cannot be rotated, so that the inner tube 41 and the first part 31 are moved relative to the outer tube 1. The tapered flange 422 is then moved relative to the expandable plates 323 on the second part 32. When the tapered flange 422 is moved away from the expandable plates 323 on the second part 32 as shown in FIG. 6, the expandable plates 323 are not expanded outward, so that the inner tube 41 can be moved along the ribs 11 relative to the outer tube 1.

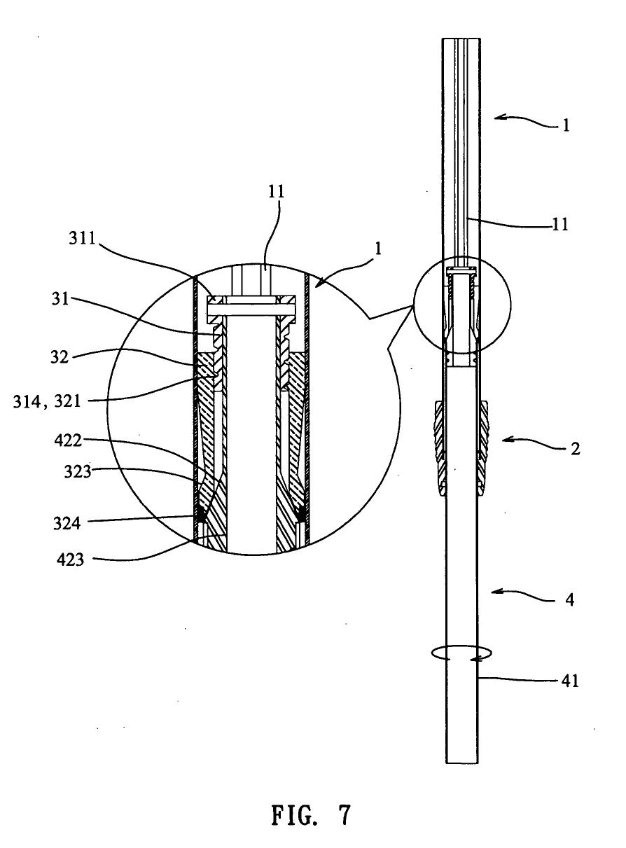

As shown in FIG. 7, when the inner tube 41 is moved to a desired position, the inner tube 41 is rotated in opposite direction, the expandable plates 323 are pushed outward by the tapered flange 422 so as to contact the inner periphery of the outer tube 1 again to position the inner tube 41. The tube assembly can also be more than two tubes.

Because the second part 32 is not rotatable relative to the outer tube 1 and is threadedly connected with the first part 31 by the pin 313, so that when rotating the inner tube 41, the connection member 42 is moved with the first part 31, the tapered flange 422 can be moved toward or away from the expandable plates 323 to control the of the inner tube 41. The inner tube 41 is moved axially by movement of the second part 32 along the ribs 11 when adjusting, so that the inner tube 41 is moved in stable manner without shaking.

While we have shown and described the embodiment in accordance with the present invention, it should be clear to those skilled in the art that further embodiments may be made without departing from the scope of the present invention.

What is claimed is:

1. A tube assembly comprising:
an outer tube;
a sleeve having an end fixedly connected to the outer tube;
an operation unit located in the outer tube and including a first part and a second part, the first part having outer threads on a first end thereof and the second part having inner threads in a first end thereof, the inner threads of the second part connected to the outer threads of the first part, the second part including multiple expandable plates extending axially from a second end thereof and slits defined between the expandable plates which contact an inner periphery of the outer tube when being expanded, and
an inner tube unit including an inner tube with a connection member on a first end of the inner tube, the connection member inserted into the operation unit and fixed to the first part of the operation unit, a tapered flange extending radially from the connection member so as to expand the expandable plates outwardly.

2. The assembly as claimed in claim 1, wherein the outer tube includes at least one rib extending axially on the inner periphery thereof.

3. The assembly as claimed in claim 2, wherein the second part of the operation unit includes at least one groove defined in an outer surface thereof and the at least one rib is engaged with the at least one groove.

4. The assembly as claimed in claim 1, wherein the first part includes
an enlarged head on a second end thereof and two first holes are defined through a wall of the enlarged head, a pin extends through the first holes.

5. The assembly as claimed in claim 4, wherein the connection member includes two second holes defined in a first end thereof and the pin extends through the second holes so as to connect the connection member with the first part.

6. The assembly as claimed in claim 1, wherein a seal ring is mounted onto the expandable plates of the second part.

7. The assembly as claimed in claim 1, wherein the sleeve includes a tapered inner periphery and includes a stepped opening in a first end thereof, the outer tube 1 is inserted into the sleeve via the stepped opening, another opening is defined in a second end of the sleeve and the inner tube is inserted into the sleeve via the another opening.

8. The assembly as claimed in claim 1, wherein another seal ring is engaged within the sleeve and mounted to the inner tube.

9. The assembly as claimed in claim 1, wherein a connection portion is located on a second end of the connection member and beside the tapered flange, an outer diameter of the connection portion is smaller than that of the tapered flange, the connection portion is inserted into the inner tube.

10. The assembly as claimed in claim 9, wherein another seal ring is mounted to the connection portion.
